(19) United States
(12) Patent Application Publication
(10) Pub. No.: US 2010/0124886 A1
(43) Pub. Date: May 20, 2010

(54) NETWORK SENSOR, ANALYZER AND ENHANCER

(76) Inventors: Bradley S. Fordham, Atlanta, GA (US); Tae Young Chang, Duluth, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/273,305

(22) Filed: Nov. 18, 2008

(51) Int. Cl. H04B 17/00

(52) U.S. Cl. 455/67.11

(57) ABSTRACT

Presented herein is a tool for analyzing spectrum in a geographic region for a variety of uses. One such use is in monitoring the operation of a wireless network and making adjustments to the wireless network components to augment operation. The tool can be used for mapping network coverage, analyzing network problems, performing network expansion planning, performing predictive analysis and maintaining reliable operation and quality of service in a network. The tool includes multiple RF sensors deployed throughout the region, and a sensor analyzer that receives input from the RF sensors, as well as other information such as mapping information and user input to control the network and report the operational state.

### BACKGROUND

The present invention is directed towards wireless network operations and, more particularly, detecting wireless network operational parameters to make adjustments to optimize or augment performance of a network, to test the environment for a new wireless network installation or the expansion of a network installation, or to simply analyze network activity for a particular frequency range within a geographic area.

The wireless transmission market has greatly expanded into a plethora of uses including cellular telecommunications, WiFi networking, and control systems. Along with each expansion, the wireless frequency spectrum becomes more crowded and prone to interference. Basically, two devices communicating on the same or proximate frequencies may potentially induce interference into the respective signal transmission of the other device. Because there is a limited amount of bandwidth, schemes have been developed to better utilize the bandwidth, such as employing the use of time-division and/or code-division multiplexing technologies. Nonetheless, given the tremendous growth in wireless applications, it is inevitable for congestion problems to arise. The Federal Communications Commission (FCC) is the governing body that regulates and controls the use of most of the wireless spectrum. As such, the FCC is able to restrict use of certain frequencies in a manner to reduce the likelihood of interference.

The structure of a cellular system is a classic example of how frequencies can be geographically restricted and reused to help improve the spectrum utilization efficiency. For a company to utilize frequencies that exist in the portions of the wireless spectrum controlled by the FCC (the licensed spectrum), considerable license fees must be incurred and performance standards must be adhered to and tested.

However, many wireless applications are deployed in the realm of the unlicensed spectrum. Due to the unlicensed nature of this portion of the frequency spectrum, anyone is able to use the available bandwidth, in any amount, and at any time. As a result, the quality of service cannot be guaranteed for subscribers to wireless systems in this spectrum.

One wireless application that may be found to use the unlicensed spectrum is WiFi networks. As such, these WiFi networks are subject to interference from other devices including other wireless networks transmitting radio signals on the same or proximate frequencies and at adequate power levels. In today's world, consumers have come to expect responsiveness in their connectivity. A user that is accustomed to operating at DSL speeds at home or T1 speeds at the office is not likely to be satisfied with sub-par performance with a wireless device. As such, providers of wireless communications must strive to provide the fastest, most reliable and most seamless service possible. To meet such objectives in the unlicensed spectrum poses several problems. Due to the “anyone can access” nature of the unlicensed spectrum, it is not possible to accurately predict congestion based on known users. As such, to meet the performance objectives in the unlicensed spectrum, it is desirable to be able to detect and identify interference within a wireless network, with sufficient specificity so as to be able to alert a network control center and provide data necessary to resolve the problem. In addition, it would be advantageous to have the ability to map the radio transmissions in a geographic area that is covered by a network or that the network may cover in the future. Such a capability would allow operators to identify competitive network coverage areas and portions of the spectrum that are crowded or wide open.

Several techniques and technologies have been presented in the past to help alleviate the above-identified issues; however, the techniques by themselves or in combination are insufficient. Some such techniques apply the use of radio frequency (RF) scanning both in fixed-installations and mobile applications. Fixed-installation techniques involve the use of scanners that are deployed within the network for detecting and reporting RF activity. Mobile application techniques involve RF information obtained by using drive-around intelligence gathering scanners. Systems that incorporate such elements are still insufficient in providing adequate information to manage wireless communications in the unlicensed spectrum.

What is needed in the art is a system and method that can reduce or alleviate interference issues for wireless communications in the unlicensed spectrum.

### BRIEF SUMMARY

Various embodiments of the present invention are directed towards a system for analyzing the spectrum in a geographic region, and using this information in the design, modification, enhancement, operational control, analysis, etc. of a wireless network. Exemplary embodiments of a solution may incorporate and include one or more of the following elements: (a) RF scanning at desired frequency ranges or at the frequency ranges of interest, (b) obtaining accurate positioning data (such as that available through the Global Positioning System (GPS) or other system) to identify the physical location associated with RF scanning readings, (c) accurate timing information to identify when RF scanning and position/location readings were taken and (d) radio and controlling software that operates to identify networks that are run and operated by a competitor and analyze the security configurations of such networks (i.e., are they open networks for anyone to access or are they secured thereby requiring encrypted credentials for access).

More specifically, one embodiment of the present invention can be seen in a system that operates to monitor, analyze and control the operation of devices communicating through a selected wireless network, as well as the operation of various network components. Such a system advantageously can provide information to an operator regarding actions that can be taken to improve the overall performance of the devices communicating over the network by making adjustments based on detected information. In addition, or alternatively, such a system may use this information to automatically take similar actions without the need for, or independent from the operator. Such an embodiment may include one or more frequency sensors and one or more sensor signal analyzers.

The frequency sensor is operable to take sample signal measurements over a portion of the frequency spectrum. As such, the frequency sensor may include a spectrum analyzer that operates to read frequency signal levels across the spectrum of frequency. In addition, the frequency sensor may include a locator system that can identify a physical location of the frequency sensor at the time of taking a sample measurement and associate that location with the reading. The locator system may take on a variety of forms including, but not limited to, a receiver that obtains location information from a positioning system, a processor that estimates a current location by differentiating on received signals, or simply a pre-determined fixed location that is programmed into the frequency sensor and constant. In addition, the frequency sensor may include a wireless network analyzer that can identify attributes of one or more wireless networks operating across at least a portion of the spectrum of frequency.

The one or more sensor signal analyzers operate to receive one or more sample measurements from one or more frequency sensors and, based on the sample measurements, performs actions to control the communication over the preferred wireless network. The signal analyzer may include a variety of additional functions such as a mapping function. The mapping function receives mapping information and correlates the mapping information with the one or more sample measurements. The mapping function can further include an output for providing rendering information for the correlated mapping information and the one or more samples. The rendering information may be limited to a selected region and/or by selected information attributes (e.g. only certain frequencies or only certain signal strengths).

The signal analyzer may also be equipped to control the communication over a wireless network, such as a preferred wireless network in a variety of manners. Non-limiting examples of such control include: (a) sending transmit power change requests to one or more devices communicating over the preferred wireless network; (b) sending signals to adjust one or more antennas in the preferred wireless network; (c) reconfiguring which access points are active in the preferred wireless network; (d) changing the spectrum that is utilized by the preferred wireless network in a particular region; (e) sending signals to alter one or more devices communicating over the preferred wireless network; (f) sending signals directed to switch from one antenna to another within the preferred wireless network; and sending signals directed to manage or control software defined radios (e.g. radios that can be reconfigured with software commands).

### BRIEF DESCRIPTION OF THE SEVERAL VIEWS OF THE DRAWING

FIG. 1 is a block diagram illustrating system components and an operating environment for one embodiment of the invention.

FIG. 2 is a system block diagram illustrating components of an exemplary RF sensor that could be incorporated into various embodiments of the present invention.

FIG. 3 is a functional block diagram illustrating function components that may exist in exemplary embodiments of an RF sensor analyzer suitable for various embodiments of the present invention.

FIG. 4 is a flow diagram illustrating the operation of one embodiment of the present invention.

### DETAILED DESCRIPTION OF EMBODIMENTS OF THE INVENTION

Various embodiments of the present invention, as well as features and aspects thereof, are directed towards providing a system and method that can improve the overall operation of wireless communication systems. More particularly, embodiments of the present invention operate to reduce or alleviate interference issues for wireless communications in the spectrum, and particularly in the unlicensed spectrum. One embodiment of the invention accomplishes this by deeply integrating and synchronizing the elements of: (a) RF scanning at desired frequency ranges or at the frequency ranges of interest, (b) obtaining accurate positioning or location data to identify the physical location associated with RF scanning reads, (c) accurate timing information to identify when RF scanning reads were taken and (d) radio and controlling software that operates to identify wireless networks (e.g., networks that are run and operated by other parties (such as a competitor)) and analyze the security configurations of such networks (i.e., are they open networks for anyone to access or are they secured thereby requiring encrypted credentials for access). Such an embodiment can operate to produce coherent output data streams that, among other things, allow for the extraction and sharing of meaningful RF conclusions with regards to RF crowding and competitive signal detection. Turning now to the figures, various embodiments of the invention, as well as features and aspects of the various embodiments of the invention, will be described more fully.

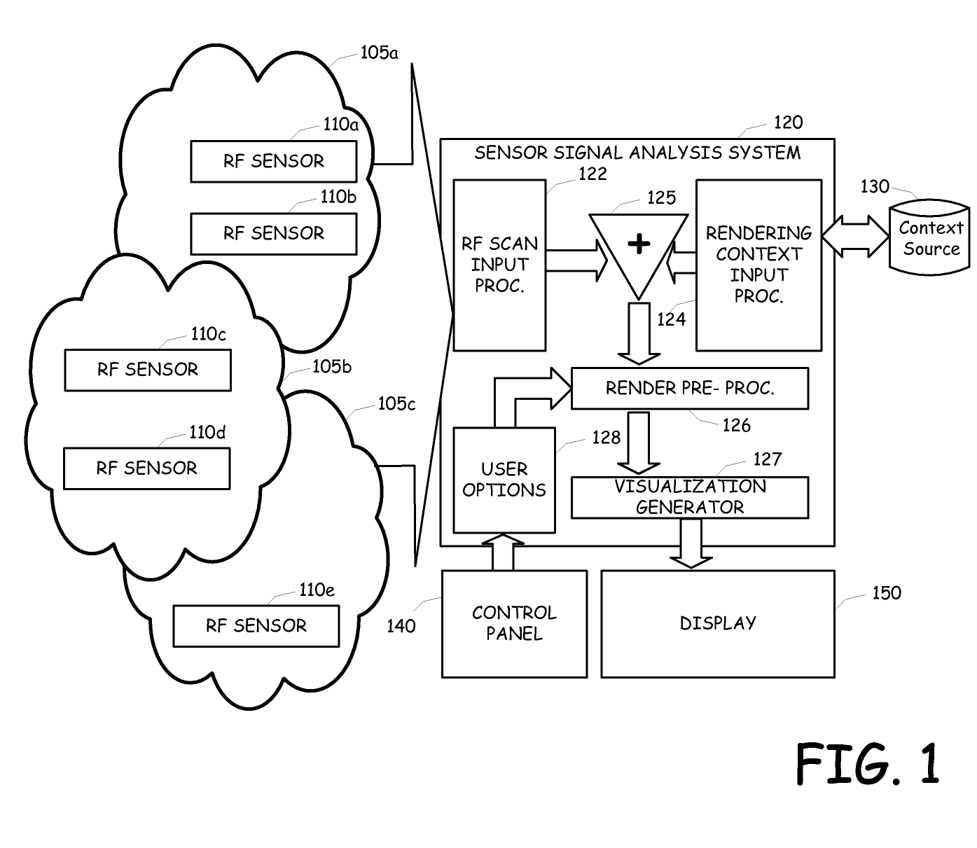

FIG. 1 is a block diagram illustrating system components and an operating environment for one embodiment of the invention. In general, an exemplary operating environment for the present invention can be any geographic region and any frequency spectrum within that geographic region. For instance, a service provider that is interested in setting up a wireless network in the state of Georgia, or in an area of South Africa, may define a geographic region of interest. Within that geographic region of interest, one or more other wireless networks or other sources of transmission signals or noise may be preset. Furthermore, the RF noise present in the geographic region may fluctuate over time. Various embodiments of the present invention may operate in such an environment to identify networks, signals and noise over time in the geographic region and use this information to adjust, optimize or control the operation of the service provider's selected wireless network.

In the illustrated environment, various sources of wireless signals and noise are shown by network clouds 105a-105c existing in a geographic region. RF sensors 110a-110e are shown as being deployed throughout the geographic region. In some embodiments, the RF sensors may be stand alone devices and in other embodiments, the RF sensors may be incorporated into infrastructure components, such as wireless access points, routers, mobile telephone switching offices, mobile devices communicating over the network, etc. The RF sensors 110 operate to take signal or noise or frequency samples at various frequencies or across particular spectrums. The information or samples obtained by the RF sensors 110 are provided to a sensor signal analysis system 120.

An RF Scan Input Process 122 within the sensor signal analysis system 120 receives signal samples from the various RF sensors 110. The illustrated embodiment is also shown with a rendering context input process 124, which in an exemplary embodiment may include a map input process. The rendering context input process 124 receives information from a context source 130. In an embodiment that includes a map input process, the context source may include a map database as a non-limiting example. Other non-limiting examples for map sources may include GPS receivers, Defense Mapping Agency websites, etc. In broader embodiments, the context source 130 may include statistical analysis, such as standard deviation, multi-dimensional rendering spaces, etc. The signal samples received by the RF Scan Input Process 122 and the rendering context information are correlated in a correlator 125 and provided to a render pre-processor 126. The render pre-processor 126, either based on predefined information or information received from a user via a control panel 140 and/or set user options 128, selects information on which to focus for rendering the correlated contextual information and signal samples. This rendering information is then provided to a visualization generator 127 which then renders the information of interest. For instance, the information may be rendered to video display device 150. Referring again to an embodiment that includes a map input process, the render pre-processor 126 may operate to select a geographical region on which to focus and then renders mapping information and signal samples. In such an embodiment, the visualization generator 127 may operate to generate and render a map overlaid with detected signaling or frequency information.

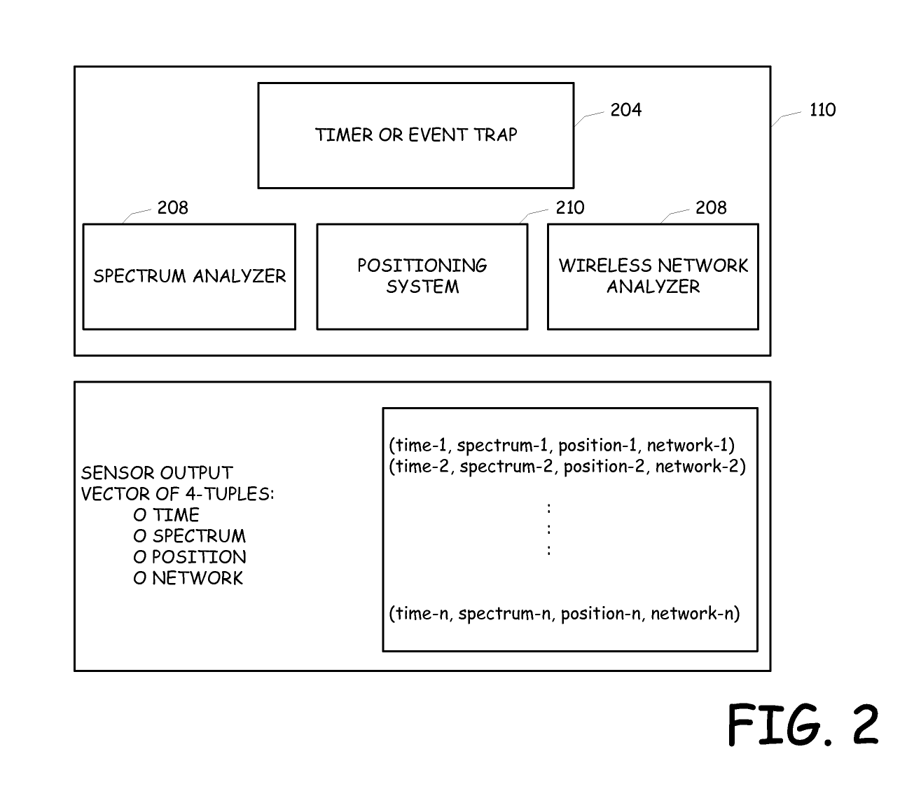

FIG. 2 is a system block diagram illustrating components of an exemplary RF sensor that could be incorporated into various embodiments of the present invention. As illustrated in FIG. 1, the RF sensors 110 can be deployed throughout a geographic region as stand-alone units, as part of the infrastructure components or even as a combination of both. In the illustrated embodiment, the RF sensor 110 includes a timer or event trap 204. The timer or event trap 204 is used to trigger readings by the RF sensor. For instance, the RF sensor may be configured to take signal sample readings periodically based on a timer or, readings may be taken upon the occurrence of one or more events. In the timer mode of operation, the RF sensor 110 may take readings on a periodic basis or, on a modified periodic basis. For instance, at certain times of the day or days of the week, the sample rate may be changed. In the event trap mode, the RF sensor may take readings based on events occurring, such as detecting high-levels of noise, detecting specific signals, etc. In addition, it will be appreciated that a combination of modes can be used (i.e., a hybrid mode). For instance, in a hybrid mode, upon detecting an event, periodic samples may be taken over a certain period of time. For instance, if an RF sensor detects that there is a high-level of traffic volume, then periodic samples may commence or the frequency of periodic samples may increase. Alternatively, periodic samples may be continuously taken but, in response to detecting an event, the sample rate may be increased or decreased. Finally, it will also be appreciated that the detected events may be control signals received from other devices, such as the sensor signal analysis system 120. In this scenario, the sensor signal analysis system 120 may request or prompt an RF sensor to commence or cease periodic sampling and provide the sampling parameters under which to operate. In some embodiments, each of the RF sensors 110 operating within a region or in support of a network may be synchronized. As such, synchronized readings across an entire network can be taken at a globally identical point in time.

Regardless of the sampling configuration, when the RF sensor 110 takes a sample, the RF sensor 110 takes a signal measurement, for example via a spectrum analyzer 208. The signal measurement may comprise a variety of types of measurements and/or may be a combination of multiple measurement types. For instance, the signal measurement may take an overall RF signal energy measurement across a frequency band of interest. As another example, the signal measurement may be taken at a specific frequency to identify RF signal energy at the frequency or channel. As another example, a spectrum of frequencies may be swept to identify any frequencies where energy is present and the level of energy present.

The RF sensor 110 may also include a positioning system 210. In one embodiment the positioning system 210 may be a global positioning system receiver. Such a system would be most useful in an embodiment in which the RF sensor 110 is mobile. In other embodiments, the position of the RF sensor 110 may be known and fixed (i.e., upon installation the positioning information can be loaded into the RF sensor). In such embodiments, the precise location of the RF sensor 110 can be determined and stored into memory or maintained by a central database or server. In other embodiments, other technology may be used such as proximate positioning based on cellular tower transmissions, etc.

A wireless network analyzer 208 can be incorporated into the RF sensor 110 to detect and identify attributes embedded in the signal samples. For instance, in one embodiment, the wireless network analyzer 208 may examine the signal sample to determine if a wireless network, such as a WiFi network is broadcasting in the vicinity. Furthermore, the wireless network analyzer 208 may operate to determine if a detected WiFi network is secure or public. Thus, the wireless network adapter 208 reads or detects the identity, encryption and other attributes of a wireless network in the vicinity of the RF sensor 110. By detecting the identity of the wireless networks in the vicinity, information about particular wireless networks may be filtered. This capability advantageously would allow an analyzer to ignore information about the operator's wireless network and simply analyze the existence of other wireless networks.

In the illustrated embodiment, for each signal sample, at least one data set of information is generated as output for the sample. As an example, the data set of information may include four items of information: (1) the time at which the signal sample was taken, (2) the signal sample, (3) the physical location of the RF sensor and (4) the network associated with the signaling energy in the sample (if any). Such a data set can be referred to as a quad-tuple. It should be appreciated that in some embodiments, the data set may include fewer or more than these four data elements and the above-listed data elements are provided as a non-limiting example. Furthermore, in some embodiments, each sample may include multiple data sets of information. For instance, the frequency spectrum may be broken down into various frequency bands or, different data sets may be generated for differing levels of energy across the spectrum. Each data set is then available as output from the RF sensor 110.

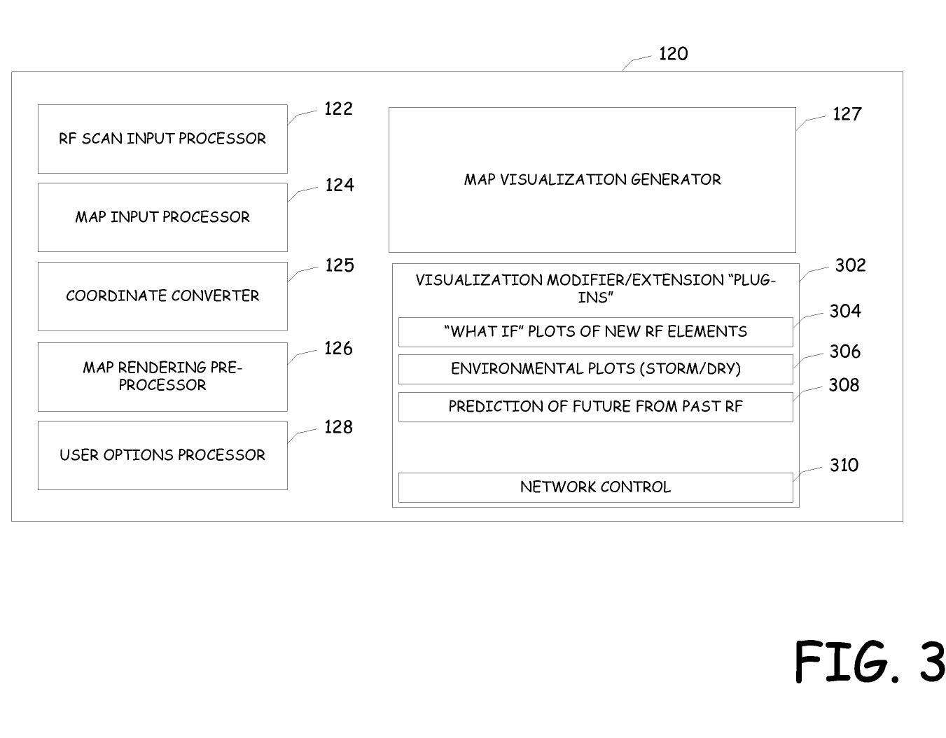

FIG. 3 is a functional block diagram illustrating functional components that may exist in exemplary embodiments of an RF sensor analyzer suitable for various embodiments of the present invention. As shown in FIG. 1, the data sets of information may be provided to the RF sensor signal analysis system 120. The RF Scan Input Processor 122 accepts data from one or more RF sensors 110, and as illustrated in FIG. 2, each data set may include for data elements. However, it will be appreciated that more or less information may be included in the samples or information provided by the RF sensors and the illustrated data sets of information are simply a non-limiting example.

The rendering context input process 124 accepts contextual information. The correlator 125 correlates the contextual information along with data received from the RF sensors. The correlated results are then provided to the render pre-processor 126. The render pre-processor then determines the scope of information to be rendered. Returning to the exemplary embodiment in which the rendering context input process 124 includes a mapping context input process, the rendering context input process may receive global map images and data that may define certain terrain or mapping characteristics for a given physical region. In this embodiment, the correlator 125 correlates the data received from the RF sensors with the map coordinates. The results from the correlator 125 are then provided to the rendering pre-processor 126. The render pre-processor 126 defines the map region to be rendered which may, or may not be based on user selected options received from the user options processor 128.

The visualization generator 127 operates to generate an output visualization or rendering of the combined contextual information and signal sample information. A variety of information can be displayed on the output, including data such as network access points, measurement points, RF noise, wireless network coverage zones, wireless network signal strengths, details of wireless network coverage such as channels, changes in values over time, the cumulative effects of signals in the same space, as well as other information.

In addition, the visualization generator 127 may include the ability to modify its functionality or capabilities by receiving modifiers or extension plug-ins 302. Several enhancements may be added to the visualization generator 127. For instance, as a non-limiting example, a plug-in may be included to enable “What If” plots of new RF elements 304. Such an enhancement would allow an operator to interject changes into a wireless network system to see what the overall effect of the changes would be. For instance, an operator may want to observe the network performance if an access point or radio is removed from the network or substituted for another type of device. This plug-in would allow the operator to logically remove or change the access point or radio configuration. The performance of the network based on previously received data can then be determined through analysis and demonstrated through the rendering. Similarly, the operator may add a wireless access point or radio device and observe the performance of the network. Other similar parameters and configurations could be modified such as adjusting transmit power for one or more transmitters, changing antenna configurations or types, reallocating frequencies and spectrum, etc.

As another non-limiting example, the visualization generator 127 may include a plug-in 306 to create plots in various environments. For instance, models can be created and loaded into the system to simulate various levels of rain (heavy, light, mist), electric storms, snow, high-winds, extreme temperatures, foliage changes, etc. Such a feature may also be able to receive topographical information defining a landscape and allow for the analysis to be performed. For instance, if a new building is projected to be erected, a simulation can be created to determine how that building will affect the network performance and topology.

As another non-limiting example, the historical data received by the visualization generator 127 may be used by a predictive plug-in 308 to model and analyze future performance of the network. For instance, past performance during certain operational conditions can be used to predict the performance of the system during an upcoming, and projected similar operational condition.

As yet another non-limiting example, a network control plug-in 310 may be included in the visualization generator 127 to perform actual network modifications, adjustments or enhancements. Many activities can be triggered/facilitated within a network as a result of information gathered and provided by the RF sensor analyzer. Thus, a plug-in can be used to analyze the system, and based on past and current information, automatically make adjustments or changes to optimize future performance of the system. Alternatively or, in addition to such automatic optimizations, this information may be used to generate and/or provide suggestions for modifying the system to a network technician or controller who can perform the changes or modifications to the system in order to change the operational characteristics (i.e., improve performance, improve reliability, improve quality-of-service, etc.). For example, the analyzer may change or suggest changing the channels that one or more transmitters/receivers within the network are utilizing to reduce conflict or interference. As another example, the analyzer may suggest changing, or automatically cause a change in, the transmit power levels on radios within an area of the wireless network to reduce interference (i.e., reduce transmit power), or to extend the communication footprint or range (i.e, increase transmit power). Other changes may include changing the position or aim in 2 or 3 dimensional space of the antennas within the network or, actually changing or swapping out the antennas themselves. Another example may even include altering the configurations of client-access devices that connect to the wireless access points. Network reconfiguration changes, such as adding, removing or moving access points may also be identified by the analyzer. Furthermore, the analyzer may suggest changing or may automatically change the spectrum that is used in an area of the network. For instance, moving from unlicensed spectrum that has become crowded to licensed spectrum may allow much better reception. Those skilled in the art will appreciate that these functions, as well as combinations of these functions, enhancements and other functions may also be incorporated into an analyzer and implemented in various embodiments of the present invention.

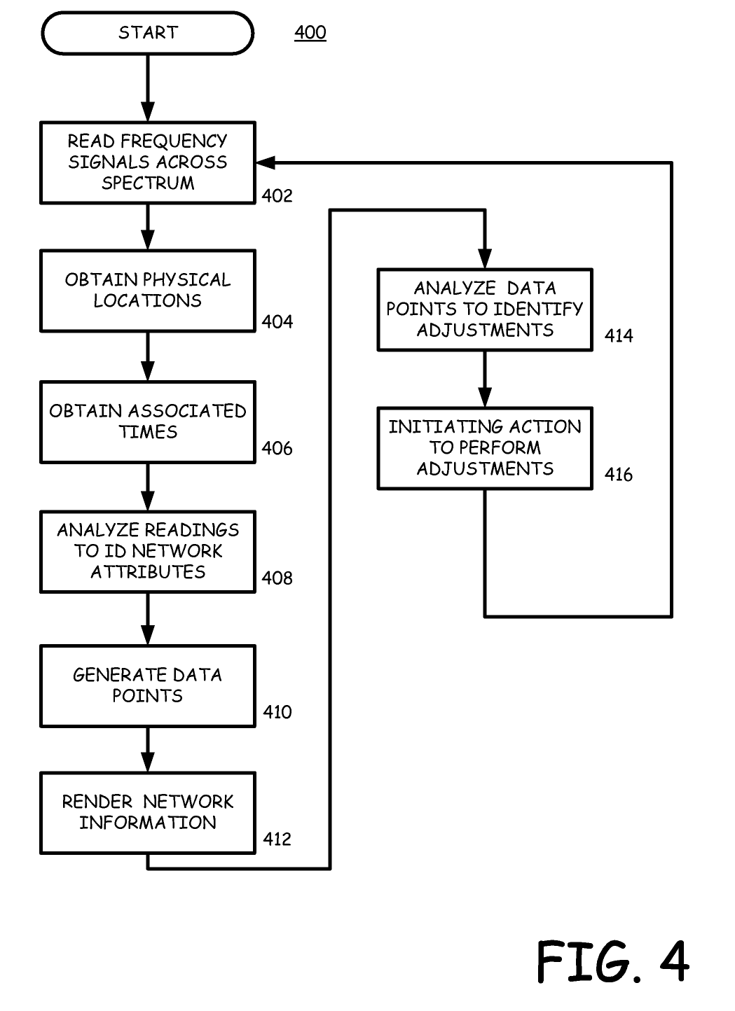

FIG. 4 is a flow diagram illustrating the operation of one embodiment of the present invention. The depicted steps 400 control the overall operation of a preferred wireless network, including infrastructure components and devices communicating over the preferred wireless network. At the onset, readings are taken of the frequency signals appearing across a spectrum of frequency or selected frequencies of interest 402. For each reading, a physical location that is associated with the device taking the reading is obtained. The physical location is associated with the reading 404. Likewise, a time and/or date is obtained and associated with the reading 406. The frequency readings are analyzed to identify attributes of one or more wireless systems that may be operating in the geographic vicinity 408. Data points are then generated that identify the readings, the time/date, the location and an associated network, if any, for each reading.

The readings can be presented to a rendering engine for rendering along with contextual information (e.g. map data) to correlate into a rendering 412. Looking at the mapping oriented embodiment, this process may include correlating the generated data points with mapping information; and rendering a map with at least a portion of the generated data points on a display device. Furthermore, the identified attributes for the frequency signal readings may be overlaid on the graphical representations on the rendered map. In addition to, or in the alternative, the data points can be used to identify issues in the wireless network and actions that can be taken to correct or rectify such issues 414. As such, this is another example of rendering the collected data into a context. Actions can then be initiated, either by request or automatically, to carry out the identified actions 416.

This process can then be repeated by once again, returning to step 402 to take additional or updated readings.

The process may also include receiving an input actuation that identifies an operator initiated adjustment to be made to the operation of the preferred wireless network. In response, the process may initiate action to perform the operator initiated adjustment. Data can then be collected again to determine the result of the operator initiated adjustment; an updated rendering based on the obtained results may be generated.

The various components and operations of differing embodiments of the invention have been presented. Those skilled in the art will appreciate that the various embodiments of the invention may be used in a variety of applications or settings. For instance, embodiments of the present invention may be used to perform competitive analysis of wireless networks. Such an application can operate to detect new wireless networks that may be setting up or, detecting established wireless networks that are expanding coverage near or around a coverage zone of interest.

Embodiments of the present invention may also be used to conduct site surveys. For instance, prior to entering into a new geographic region, an operator may want to conduct an assessment of that geographic region. An embodiment of the present invention may be used to analyze the RF noise in the geographic region and/or surrounding regions where the network would be installed or into which a previously installed network is expanding. In such an embodiment, the overall signal characteristics of a region can then be sampled and analyzed to: determine what type of system to deploy; how to expand an existing system so as to avoid interference issues or to address bandwidth or resource deficiencies; what other systems in the area can be exploited; etc.

Another application for embodiments of the present invention is in the area of generating coverage maps. A new or existing network can be easily characterized and updated in real time to show the actual coverage of the network on a satellite, topographical or other map.

The various embodiments of the present invention can advantageously be used for troubleshooting a wireless network. Such an embodiment can detect areas of the network that may be experiencing substandard performance and then conduct an analysis of that area. The various system components can enable the system to not only identify where the problem exists, but to also determine the contributing causes to the problem and propose solutions to alleviate the problem.

Another application of various embodiments of the present invention is to provide an evaluation and analysis for new frequency expansions in an area. For instance, embodiments of the present invention can provide knowledge with regards to the noise that may exist in an area relevant to a new or specific portion of the spectrum (e.g., the 900 MHz range). Such capabilities provide a scientific evaluation of the potential to extend operation and coverage into a new frequency domain with or without acceptable noise or interference.

A very practical application of various embodiments of the present invention is simply in the management and optimization of a wireless network. All aspects of the network can continuously be monitored and adjusted to ensure acceptable connectivity and quality of service.

Yet another application of embodiments of the present invention includes a very sophisticated form of what is termed “war driving”. War driving involves driving a new area and mapping out available wireless network coverage zones. This activity may also include looking for and identifying unsecured networks that may be accessed and utilized.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit”, “module” and “component” are used interchangeably. Anything designated as a unit, module or component may be a stand-alone unit or a specialized module. A unit, module or component may be modular or have modular aspects allowing it to be easily removed and replaced with another similar unit, module or component. Each unit or module may be any one of, or any combination of, software, hardware, and/or firmware.

As previously described, the present invention may be incorporated into various embodiments, some of which have been presented as non-limiting examples. Prototypes of various embodiments have been constructed and tested. As a non-limiting example and simply to further an understanding of the overall operation of embodiments of the present invention, various components, software modules, configurations and characteristics of various embodiments are presented in Table 1—Hardware Descriptions, Table 2—Software Descriptions and Table 3—Descriptions of Supported Processes/Analyses.

TABLE 1
Hardware Descriptions

```
MetaGeekWi-Spy 2.4x Spectrum Analyzer
    Chipcon CC2500 RF Transceiver
          Used in wireless mouse, keyboard,
          game controller, and other low-
          speed wireless communication (up to 500 kbps)
          Frequency band: 2400~2484 MHz w/ 0.328-MHz resolution
              Up to 256 samples per sweep-time
              64-byte buffer
          Amplitude range: from −110 dBm
          to −6.5 dBm w/ 0.5 dBm resolution
          Modulation: FSK, GFSK, MSK, OOK
    Silicon Labs C8051F326 USB Microcontroller
          16-kb flash
Proxim Orinoco 11b/g PC Card Silver 8471-WD
    Atheros AR5212 chipset
          Frequency band: 2400~2484 MHz
          rfmon (monitor) mode enabled
          Supported by Madwifi driver
    Maximum output power: 60 mW in 802.11g, 85 mW in 802.11b
    PCMCIA interface
GlobalSat GPS Navigation Receiver BU-353
    SiRF III chipset
          Scans up to 20 channels simultaneously
          NMEA 0813 v2.2 protocol w/ virtual COM emulation
          WAAS capable
          No external antenna connection
    USB interface
    Magnetic base
```

TABLE 2
Software Descriptions

```
Fedora 8 Operating System
    Kernel version: 2.6.24.5
Spectools
    Developed as a 3rd-pary program for Wi-Spy 2.4x
        For Linux in C
        Current version: 2007-10-R2
    wispy24x.c/h
        Imported necessary functions from it
Madwifi driver
    Developed for Atheros-based 802.11 cards
        For Linux in C++
        Does not override the default drivers in Fedora 8
    Current version 0.9.4
        Modified ieee80211_ioctl_siwscan( ) in
        /net80211/ieee80211_wireless.c
            Added IEEE80211_SCAN_FLUSH flag when calling
            ieee80211_start_scan
    normal_scan.c/h
        It performs active/passive scans using Madwifi driver.
Kismet
    Developed for monitor-mode scanning
        For Linux in C
    Current version: 2007-10-R1
        kismet_server
            Scan Access Points by capturing 802.11 frames and analyze
            them using its own algorithm
            Run with no-logging/no-display (-n -s) options
            Modified ProcessPacket( ) in server_protocols.cc
        kismet_client
            Imported necessary functions: monitor_scan.c
Wireless-Tools
    Used in most Linux kernels
        Developed by HP Labs for Lunix in C
    Current version: 29
        Imported some functions and modified them
            iwlist, iwconfig, etc.
gpsd
    Developed for Linux environments
        Supports generic NMEA, SiRF binary, etc.
    gps.c communicates with the gpsd server.
Custom Software (Written in the C Programming Language)
    measure.c/h
        Get scanning mode information from user
            Support active/passive/monitor-mode scanning
        Generate commands of device detection, initialization, and
        measurement
            If necessary, generate commands to open Kismet and gpsd
            servers
        Complete a full spectrum data set from partial data sets
            Complete a 256-sample set by multiple readings of 64 bit
    wispy24x.c/h
        Scan Wi-Spy device
            Support multi-device operations
        Initialize and calibrate Wi-Spy devices
            Calculate and set best parameters for operations
        Generate a separate thread for blocking reads from Wi-Spy
            Maximum reading rate: 64 bits per 80 ms
            (5 reads = a full data
            set.)
            Dual reading: The main thread reads 64-bit data from this
            thread.
    normal_scan.c/h
        Initialize 802.11 cards using Madwifi driver
            Set up the main controller (physical 802.11 card): wifi0
            Generate a virtual 802.11 card (VAP): wlan0
            Wake up both cards
        Perform active/passive scan
            Set and send scan parameters/commands
            Readand analyze AP information
    monitor_scan.c
        Run and connect to Kismet server
            Run the server in a separate thread
            Port: 2501 @ localhost
        Send a scan command to Kismet server
            Set desired parameters and send them
            Once the command is delivered, the server performs the
            operation recursively.
        Read AP information from the server and analyze it
            Read each AP informationin real-time
            Store data generated within a specific time slot
            Sort selected data
    gps.c
        Run and connect to gpsd server
            Generate a separate thread for running the server
        Send a command to gpsd server
            Request location, speed, direction, and time data
        Read and analyzer gps data
```

TABLE 3
Descriptions of Supported Processes/Analyses

```
Spectrum Analysis
    Measure spectrum in 2400-2483 MHz band
        Same as the 802.11b/g/n band
    Parameters
        We unlocked parameters that are used in Spectools and
        Chanalyzer
            Channel spacing (CHANSPC): 0..026367~0.404571 MHz
            Channel bandwidth (CHANBW): 0.060268~0.843750 MHz
        Currently, we use the recommended values to synchronize both
        parameters
            Bandwidth resolution: 0.328 MHz (256 samples
            for entire band)
            Same as in Wi-Spy and CircuitCellar
    Metrics
        Signal Strength: before demodulation
            From −110 dBm to−6.5 dBm w/ 0.5 dBm resolution
GPS Information Analysis
    Measure location and other data by synchronization with
    GPS satellites
        Needs minutes to get signals from satellites
        Needs LOS with satellites: only for outdoor environments
    Metrics
        Location: Latitude, Longitude, Altitude
        Others: Speed, Direction, and Time
Access Point (AP) Information Analysis
    Perform AP scanning in one of the following three modes
        Active Mode
            Allows probing with the “ANY” option
            for hidden-SSID APs
            However, most APs do not respond for ANY probing
            packets.
        Passive Mode
            Not allow to perform probing, but may send frames of other
            types
            May affect current transmissions of others
        Monitor (rfmon) Mode
            Not allowed to send any packets
            Kismet server captures and analyzes all wireless
            frames to detect
            all SSIDs
        A single 802.11 card can operate only in a single mode.
            Multiple cards can perform multi-mode operations or
            collect
            more data in a single mode.
    Parameter:
        Sweeping time
            Currently, sweeping time is set as 400 ms
            (minimum value).
                Sweeping time can be increased if necessary
            Active/passive scan performed by Madwifi driver
                Minimum 300 ms for entire scan
            Monitor-mode scan with Kismet server
                Detection messages are transmitted individually
                in real-time.
                Collect each message based on its timestamp
                Need to set a timeslot instead of sweeping time
    Metrics
        SSID, BSSID(MAC address)
        Channel Number, Max Rate (802.11b/g mode)
        Signal Strength (RSSI): after demodulation
            Because of dispreading, this value may become larger
            than raw
            signal strength measured by spectrum analyzer.
        Noise strength (floor level: −94 dBm),
        Encryption (optional in KSismet)
```

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A radio frequency analysis system comprising:
one or more frequency sensors operable for taking sample measurements, each frequency sensor comprising:
a device that operates to read frequency signal levels at one or more frequencies;
a locator system that operates to identify a physical location of the frequency sensor at the time of taking a sample measurement;
a sensor signal analyzer operable to receive one or more sample measurements from one or more frequency sensors and based on the sample measurements, generate information based on which actions to control the communication over a preferred wireless network can be performed

2. The system of claim 1, wherein the sensor signal analyzer comprises a correlation function that receives contextual information and correlates the contextual information with the one or more sample measurements.

3. The system of claim 2, wherein the correlation function further comprises an output for providing rendering information of the correlated contextual information and the one or more samples.

4. The system of claim 3, wherein the contextual information is limited to a selected region.

5. The system of claim 3, wherein the contextual information comprises mapping information.

6. The system of claim 1, wherein the sensor signal analyzer is operable to control the communication over the preferred wireless network by sending control requests to one or more devices communicating over the preferred wireless network.

7. The system of claim 1, wherein the sensor signal analyzer is operable to control the communication over the preferred wireless network by sending signals to adjust one or more antennas in the preferred wireless network.

8. The system of claim 1, wherein the sensor signal analyzer is operable to control the communication over the preferred wireless network by reconfiguring which access points are active in the preferred wireless network.

9. The system of claim 1, wherein the sensor signal analyzer is operable to control the communication over the preferred wireless network by changing the frequencies that are utilized by the preferred wireless network in a particular region.

10. The system of claim 1, wherein the sensor signal analyzer is operable to control the communication over the preferred wireless network by sending signals directed to change one or more antennas within the preferred wireless network.

11. A radio frequency analysis system comprising:
one or more frequency sensors operable for taking sample measurements, the frequency sensor comprising:
a device that operates to read frequency signal levels at one or more frequencies;
a locator system that operates to identify a physical location of the frequency sensor at the time of taking a sample measurement;
a sensor signal analyzer operable to receive one or more sample measurements from the one or more frequency sensors and based on the sample measurements, the sensor signal analyzer comprises a mapping function that receives mapping information and correlates the mapping information with the one or more sample measurements.

12. A method for monitoring and analyzing frequency signals over a range of one or more frequencies, the method comprising the steps of:
reading frequency signals across one or more frequencies;
obtaining a physical location associated with each frequency signal reading;
obtaining a time associated with each frequency signal reading;
analyzing the frequency signal readings to identify attributes of one or more wireless systems operating across at least a portion of the one or more frequencies;
generating data points, with each data point including a frequency signal reading, an associated physical location, an associated time and the identified attributes;
analyzing the generated data points to identify adjustments that can be made to the operation of the preferred wireless network; and
initiating action to perform the identified adjustments.

13. The method of claim 12, after initiating action to perform the identified adjustments, further comprising the steps of:
reading new frequency signals across the one or more frequencies;
obtaining a physical location associated with each new frequency signal reading;
obtaining a time associated with each new frequency signal reading;
analyzing the new frequency signal readings to identify attributes of one or more wireless systems operating across at least a portion of the one or more frequencies;
generating updated data points, with each updated data point including a new frequency signal reading, an associated physical location, an associated time and the identified attributes;
analyzing the updated generated data points to identify additional adjustments that can be made to the operation of the preferred wireless network; and
initiating action to perform the identified additional adjustments.

14. The method of claim 12, further comprising the steps of:
correlating the generated data points with contextual information; and
rendering at least a portion of the generated data points correlated with the contextual information.

15. The method of claim 14, further comprising generating graphical representations of the identified attributes for the frequency signal readings and overlaying the graphical representations on a rendered map.

16. The method of claim 15, further comprising the steps of:
receiving an input actuation that identifies an operator initiated adjustment to be made to the operation of the preferred wireless network;
initiating action to perform the operator initiated adjustment;
obtaining information resulting from the operator initiated adjustment; and
updating the rendering information based on the obtained results.

17. The method of claim 16, wherein the step of obtaining information resulting from the operator initiated adjustments further comprises the steps of:
reading new frequency signals across the one or more frequencies;
obtaining a physical location associated with each new frequency signal reading;
obtaining a time associated with each new frequency signal reading;
analyzing the new frequency signal readings to identify attributes of one or more wireless systems operating across at least a portion of the spectrum of frequency; and
generating updated data points, with each data point including a frequency signal reading, an associated physical location, an associated time and the identified attributes;

18. A frequency sensor device for operating in conjunction with a preferred network monitoring and control system, the frequency sensor device comprising the components of:
a device that operates to read frequency signals across one or more frequencies;
a locator system that operates to identify a physical location of the frequency sensor at the time of taking a frequency reading;
a data point generator for generating a plurality of data points, with each data point including a spectrum identification associated with a portion of the frequency signal reading, a physical location associated with the spectrum identification, and a time associated with the spectrum identification.

19. The frequency sensor device of claim 18, further comprising a wireless network analyzer that is operable to identify attributes of one or more wireless networks operating across at least a portion of the one or more frequencies and wherein the data point generator further includes a wireless network identifier associated with the spectrum identification of the frequency signal reading.

20. The frequency sensor of claim 18, wherein the locator system comprises a global positioning system receiver.

21. The frequency sensor of claim 18, wherein the wireless network analyzer is further operable to determine if each of the one or more wireless networks is secured or unsecured.
